(19) United States
(12) Patent Application Publication
(10) Pub. No.: US 2009/0257392 A1
(43) Pub. Date: Oct. 15, 2009

(54) System and Method for Efficiently Packing Two-Dimensional Data Bursts in a Downlink of a Wireless Communications System

(75) Inventor: Patrick Hosein, San Diego, CA (US)

Correspondence Address: Slater & Matsil, L.L.P., 17950 Preston Road, Suite 1000, Dallas, TX, 75252, US

(73) Assignee: FutureWei Technologies, Inc., Plano, TX (US)

(21) Appl. No.: 12/423,672

(22) Filed: Apr. 14, 2009

Related U.S. Application Data
(60) Provisional application No. 61/044,798, filed on Apr. 14, 2008.

(51) Int. Cl. H04W 72/04

(52) U.S. Cl. 370/329

(57) ABSTRACT

A system and method for packing two-dimensional data bursts in a downlink of a wireless communications system is provided. A method includes allocating resource units to users in the wireless communications system, and packing allocated resource units into rectangular bursts for transmission. The allocating is based on delay characteristics of the user and an amount of information to be transmitted to each user.

This application claims the benefit of U.S. Provisional Application No. 61/044,798, filed on Apr. 14, 2008, entitled “Method and Apparatus for Efficiently Packing Two Dimensional Data Bursts in the Downlink of an OFDMA Network,” which application is hereby incorporated herein by reference.

### TECHNICAL FIELD

The present invention relates generally to wireless communications, and more particularly to a system and method for packing two-dimensional data bursts in a downlink of a wireless communications system.

### BACKGROUND

Wireless communications systems have enabled an unprecedented degree of freedom to users. A user may be able to communicate wirelessly while on the move. Furthermore, wireless communications systems allow for rapid deployment of an information infrastructure without having to incur the expense of wiring. FIG. 1 illustrates a wireless communications system 100. Wireless communications system 100 includes a base station (BS) 105. BS 105 may be responsible for serving mobile stations (MSs) operating within its coverage area, including but not limited to MSs 110 through 114. In general, BS 105 may transmit information for a MS over a downlink (DL) and allocate resources to a MS on an uplink (UL) based on a resource request for the MS.

Orthogonal Frequency Division Multiple Access (OFDMA) transmission technology has been chosen for the next generations of wireless cellular networks which include 802.16 (WiMAX), Long Term Evolution (LTE) and Ultra Mobile Broadband (UMB). OFDMA together with the wider bandwidths available for fourth generation (4G) networks has made it possible to support high data rates and real time services to a large number of users. However, in order to fully utilize such a network, resources must be efficiently allocated while satisfying the Quality of Service (QoS) guarantees of each user's applications.

In OFDMA, a frame consists of a set of subcarriers in the frequency domain and a set of symbols in the time domain. A subset of subcarriers together forms a subchannel. In the Full Usage of Subchannels (FUSC) and Partial Usage of Subchannels (PUSC) modes, the subcarriers of a subchannel are spread over the entire bandwidth to achieve frequency diversity. FUSC uses a frequency reuse factor of one (1) while PUSC uses a factor of three (3). In the Band Adaptive Modulation and Coding (AMC) mode, consecutive subcarriers are chosen for the subchannel. Band AMC mode, which is used for frequency dependent scheduling, will not be addressed further herein.

In the distributed subcarrier case, all subchannels have the same expected transmission rate for a given user since the expected signal and interference to noise ratio (SINR) for each is averaged over the entire bandwidth. Therefore the specific placement of a subchannel within a frame is irrelevant. Each subchannel may be considered as a logical unit so that a frame consists of a matrix with subchannels in the vertical direction and symbols in the horizontal direction.

FIG. 2 illustrates a structure of a frame 200 in a TDD OFDMA wireless communications system. Frame 200 includes frequency resources (subcarriers) and time resources (symbols) that may be assigned for different purposes. In a TDD OFDMA wireless communications system, frames include both a downlink subframe (DL subframe 205 of frame 200, for example) and an uplink subframe (UL subframe 210 of frame 200, for example). Since the downlink subframe and the uplink subframe share common frequency resources, they are transmitted at different times to prevent interference. A transmission gap (a guard 215) separates DL subframe 205 and UL subframe 210.

DL subframe 205 includes a preamble 217 that may be used for synchronization purposes, a frame control header (FCH) 219 that may contain frame configuration parameters, a DL map 221 and a UL map 223 that may contain subchannel and symbol slot allocations for scheduled DL and UL users together with other control information, and user data bursts (for example, DL burst 225). UL subframe 210 contains user data bursts, such as UL burst 227, and a ranging field 229 that may contain data for use in synchronization operations.

DL subframe 205 also includes a MBS-MAP 230 and a MBS zone 235. MBS-MAP 230 may be used to specify physical layer parameters, such as modulation and coding scheme, location and time of burst(s) within MBS zone 235, and so forth. A mobile station may first read MBS-MAP 230 to determine the location and decoding parameters for a stream in MBS zone 235 that it is to receive, and then access and decode the information at the specified location. MBS-MAP 230 or MBS zone 235 may also include information (such as an index, an offset, a pointer, and so forth) regarding an indicator the next frame for the channel for each terminal.

Each user is (logically) allocated zero or more consecutive subchannels over zero or more consecutive symbols in each frame. Therefore the allocated region is rectangular in shape. The region may be referred to as a burst. If a burst is allocated to a user, its location must be signaled so that the user knows where to look for its data. This signaling is included in a DownLink MAP (DL-MAP) which is transmitted before the data region. The burst is signaled with a pointer to its top left location (symbol, subchannel coordinates) together with the width (number of symbols) and the height (number of subchannels) of the burst (shown collectively as lettered circles A, B, C, and D in FIG. 2, respectively). Multiple bursts may be allocated to a single user but each such burst must be signaled. This signaling overhead must be taken into account when constructing bursts.

The size of a burst allocated to a user depends on the number of data bits that must be transmitted to the user (determined by the scheduler) as well as the channel conditions of the user (i.e., the Modulation and Coding scheme (MCS) chosen for the user based on reported channel conditions). The rectangular burst shape constraint complicates the burst size determination. Furthermore, to increase efficiency, bursts for all users must be packed within the frame as well as possible. This problem can be shown to be NP-Complete and hence heuristics are needed.

One prior art technique, referred to as a raster scanning approach, proposes that resources be allocated to a user in a contiguous fashion in the time direction until all symbols are exhausted. If more resources are needed for the user the allocation is continued in the following subchannel. However, this may result in multiple burst assignments to each user and for time sensitive applications in which many low bitrate users are supported the resulting signaling overhead may be very large.

Another prior art technique attempts to reduce the signaling overhead by instead allocating resources in the vertical (subchannel direction) in what are call buckets. If multiple buckets are needed for a user because the number of vertical slots is insufficient to meet demand, then additional buckets are allocated. However, the bucket sizes for each user are maintained at the same size so that collectively they may form a rectangular burst. This approach has better performance but suffers when the burst size requirements among users varies dramatically.

### SUMMARY OF THE INVENTION

These and other problems are generally solved or circumvented, and technical advantages are generally achieved, by embodiments of a system and method for packing two-dimensional data bursts in a downlink of a wireless communications system.

In accordance with an embodiment, a method for allocating resources in a wireless communications system is provided. The method includes allocating resource units to users in the wireless communications system, and packing allocated resource units into rectangular bursts for transmission. The allocating is based on delay characteristics of the user and an amount of information to be transmitted to each user.

In accordance with another embodiment, a method for allocating resources in a wireless communications system is provided. The method includes allocating resource units to users in the wireless communications system, assigning allocated resource units of size M*N to M rows of resource units, and packing allocated resource units of size less than N into rectangular bursts. The allocating is based on delay characteristics of the user and an amount of information to be transmitted to each user. Where M is an integer and N is the number of resource units in a row of resource units.

In accordance with another embodiment, a method for transmitting information in a wireless communications system is provided. The method includes allocating resource units to users in the wireless communications system, packing allocated resource units into rectangular bursts for transmission, indicating allocated resource units to users, and transmitting to users using the allocated resource units. The allocating is based on delay characteristics of the user and an amount of information to be transmitted to each user.

An advantage of an embodiment is that a high packing efficiency is achieved without requiring a large amount of computational power. This may help to improve scheduling and resource allocation performance. Furthermore, the relatively small amount of computation required leads to easy implementation.

A further advantage of an embodiment is that a low amount of signaling is required. The low signaling overhead may help to improve overall wireless communications system performance by reducing an amount of system bandwidth consumed by signaling.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1 is a diagram of a wireless communications system;

FIG. 2 is a structure of a frame in a time division duplex orthogonal frequency division multiple access wireless communications system;

FIG. 3 is a flow diagram for packing two-dimensional data bursts into a downlink of a wireless communications system;

FIG. 4 is a flow diagram for scheduler operations in the allocation of transmission resources to users;

FIG. 5 is a pseudo-code description of scheduler operations;

FIG. 6 is a flow diagram for base station operations in packing allocated network resources into rectangular bursts;

FIG. 7a is a flow diagram for base station operations in an initial packing of allocated network resources into a frame;

FIG. 7b is a flow diagram for base station operations in an initial packing of allocated network resources into a frame;

FIG. 8 is a flow diagram for base station operations in a packing of allocated network resources into unallocated network resources of a frame;

FIG. 9 is a pseudo-code description of base station operations;

FIG. 10 is a diagram of 12 rows of network resource assignments;

FIG. 11 is a data plot of the ratios for the utility, the throughput, the fairness and the average and maximum queue size; and

FIG. 12 is a flow diagram of base station operations in transmitting information to users.

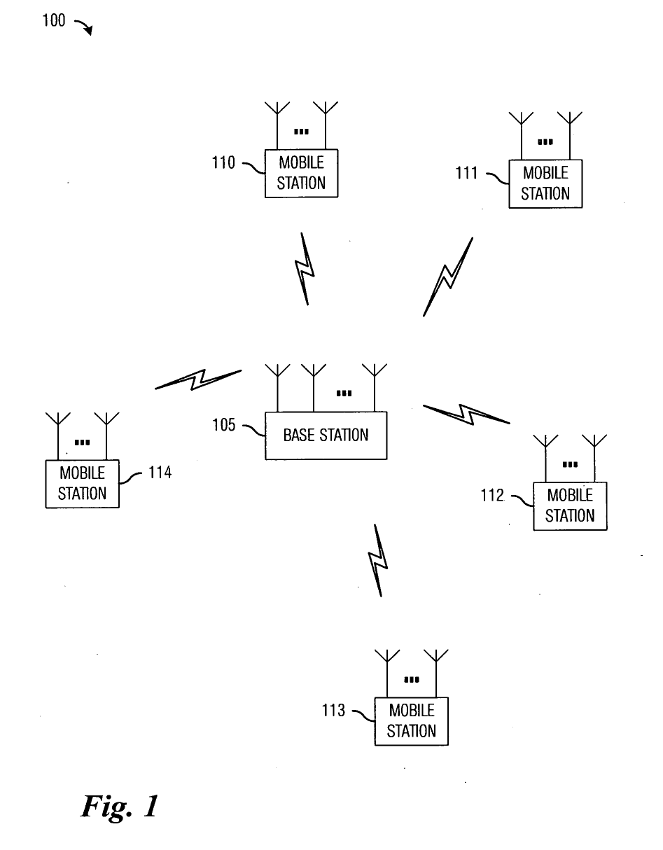

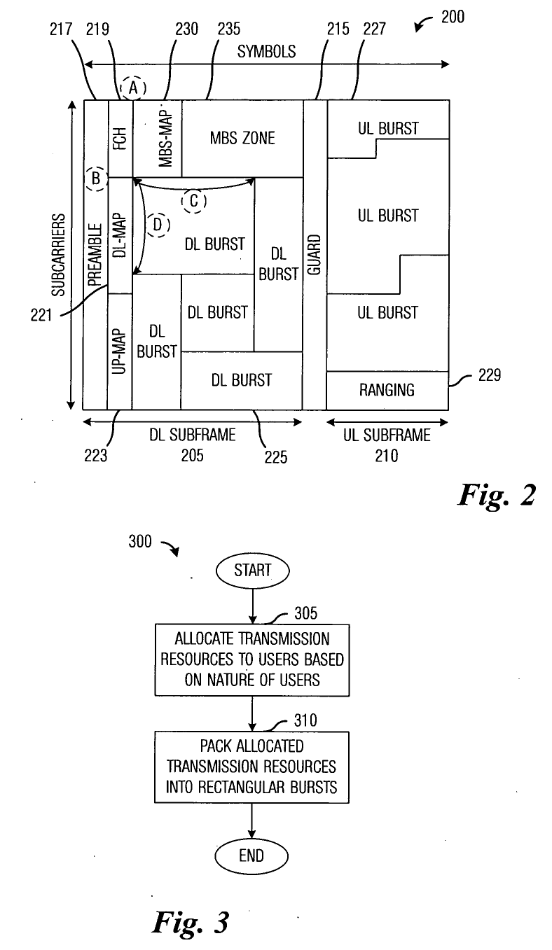

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a wireless communications system using OFDMA transmission technology. The invention may also be applied, however, to other OFDMA based wireless communications systems, including those implementing multiple input, multiple output (MIMO) transmissions, both single user and multi-user.

FIG. 3 illustrates a flow diagram for packing two-dimensional data bursts in a downlink 300 of a wireless communications system. Efficient packing of two-dimensional data bursts in a downlink 300 of a wireless communications system may be a multi-stage process that includes allocating transmission resources to users based on a nature of the users (block 305) and then packing the transmission resources into rectangular bursts (block 310).

According to a preferred embodiment, the multiple stages of efficient packing of two-dimensional data burst in a downlink 300 may occur in a scheduler of a base station. Alternatively, the allocation of transmission resources to users may take place in a scheduler of a base station, while the packing the transmission resources may take place in a processor, processing element, controller, a dedicated integrated circuit, or so forth, of a base station.

A scheduler may be used to allocate network resources (i.e., frequency resources (subcarriers) and time resources (symbols)) to users making resource allocation requests. The scheduler may be a part of a BS controlling communications within a wireless communications system and serving MSs operating within the BS's coverage area. The scheduler may operate prior to a frame of the wireless communications system to allocate network resources to users in the frame.

The next generation of wireless networks will support a wide variety of applications, ranging from time-sensitive Voice over IP (VoIP) service to throughput intensive broadcast services. Each application requires certain Quality of Service (QoS) guarantees in order to provide acceptable user level performance. These QoS attributes typically include bounds on one or more of a connection's throughput, delay, jitter, and packet loss rate. The scheduler tries to satisfy these constraints as closely as possible as it allocates network resources to users' resource allocation requests. The packet loss rate is controlled by the residual physical layer frame error rate as well as the parameters used for the MAC layer ARQ protocol and so will not be discussed.

Applications generally fall into one of two categories: delay tolerant and delay sensitive. Delay sensitive applications typically have constraints on the maximum delay, jitter and the maximum packet loss rate. If the maximum delay requirement is not met by a packet then the packet is dropped and this affects the packet loss rate. Therefore this implies that if the traffic rate is r and the target loss rate is ε then the throughput is at least r(1−ε) and hence there is no need to place a minimum throughput constraint on this type of traffic. Such traffic must typically be served often but with small payloads.

In the case of delay tolerant traffic, throughput is usually of greater concern than delay. The application level throughput may depend on delay but the time scale for the corresponding parameters are generally much larger than the physical layer frame transmission period. For TCP/IP traffic, the bottleneck tends to be the radio channel and hence significant queueing is performed at the base station. High rates require low delays while low rates can support relatively high delays, so that in both cases the scheduler can wait for a sufficiently large queue to build before serving the delay tolerant user.

Therefore, users may be divided into two groups: delay sensitive and delay tolerant. If a delay sensitive user is picked by the scheduler, then all (or most) of its data should be served to minimize signaling. On the other hand, a delay tolerant user should not be served until sufficient data (based on any rate guarantee) has accumulated in its queue.

Each user must be allocated sufficient resources so that the QoS constraints of the underlying applications are satisfied. The scheduler is responsible for taking these QoS constraints into account when making resource allocations. Furthermore, the scheduler should provide no more resources than is necessary to achieve these QoS constraints in order to maximize the total number of users that are supported. However, one also needs to take into account the burst packing efficiency as well as the signaling overhead.

Assumptions include a utility-based scheduling approach in which a utility function is assigned to each user and the objective is to maximize the sum utility over all users. These utilities are typically functions of one or more performance metrics such as throughput, maximum delay, jitter and packet error rate. More details on utility-based scheduling for OFDMA-based networks may be found in paper P. Hosein, “On the Optimal Allocation of Downlink Resources in OFDM-Based Wireless Networks,” Lecture Notes in Computer Science, Vol. 3970/2006, Chapter 15, which is incorporated herein by reference.

Additional assumptions include a basic resource unit (number of symbols together with a number of subcarriers) which is call a slot. For the case of PUSC and FUSC one can show that the optimal scheduling approach is to iteratively allocate one basic resource unit at a time. Within each iteration the utility gain in allocating the resource to each user is determined and the resource is then assigned to the user with the largest gain. All utility parameters (throughput, delay, jitter, etc.) are then recomputed before allocating the next unit.

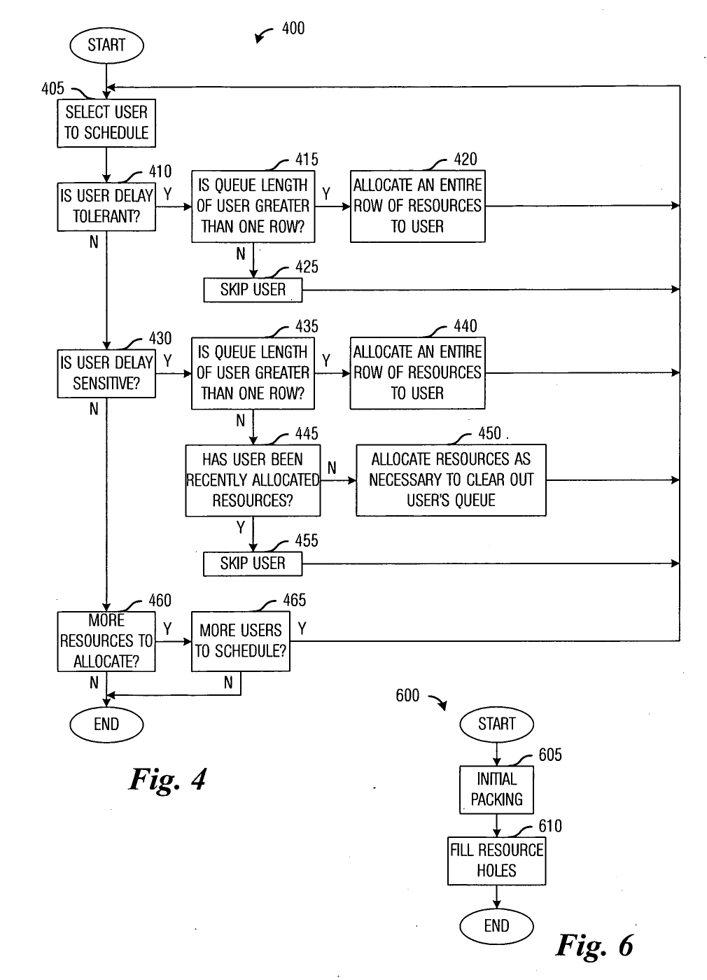

FIG. 4 illustrates a flow diagram for scheduler operations 400 in the allocation of transmission resources to users. Scheduler operations 400 may be an implementation of block 305 of FIG. 3, the allocating of transmission resources to users based on a nature of the users. Scheduler operations 400 may be in continuous operation while a base station containing the scheduler is controlling transmissions in a wireless communications system.

Scheduler operations 400 may begin with the scheduler selecting a user with a resource allocation request to schedule (block 405). The scheduler may pick a user that has a largest utility gain per additional slot, for example. Alternatively, the scheduler may pick a user based on any of a number of other criteria, such as age of resource allocation request, user priority, data priority, and so forth. In general, utility functions may be used to determine relative priorities between delay sensitive and delay tolerant users. Typically, delay sensitive users may be given much higher priorities and may therefore be picked before delay tolerant users.

The scheduler may perform a check to determine if the user is a delay tolerant user (block 410). If the user is a delay tolerant user, then the scheduler may check to determine if a queue length of a queue associated with the user is greater than a number of network resources in a single row (block 415). If the queue length is greater than the number of network resources, then the scheduler may allocate an entire row of network resources to the user (block 420). The scheduler may then return to block 405 to select another user.

If the user is a delay tolerant user (block 410) but the queue length of the queue associated with the user is not greater than the number of network resources in a single row (block 415), then the scheduler may simply elect to skip the user and its resource allocation request to allow more data to enter its queue (block 425). The scheduler may then return to block 405 to select another user.

If the user is not a delay tolerant user (block 410) then the scheduler may perform a check to determine if the user is a delay sensitive user (block 430). If the user is a delay sensitive user, then the scheduler may perform a check to determine if the queue length of the queue associated with the user is greater than the number of network resources in a single row (block 435). If the queue length of the queue is greater than the number of network resources in a single row, then the scheduler may allocate an entire row of network resources to the user (block 440). The scheduler may then return to block 405 to select another user.

If the queue length of the queue associated with the user is not greater than the number of network resources in a single row (block 435), then the scheduler may perform a check to determine if the user has recently been allocated some network resources (block 445). If the user has not been recently been allocated network resources, then the scheduler may assign as many network resources as available and as necessary to clear out as much of the queue associated with the user as possible (block 450). A definition of recently allocated may be that the user has already been allocated network resources in the frame. The scheduler may then return to block 405 to select another user.

If the user has been recently allocated network resources (block 445), then the scheduler may elect to skip the user and its resource allocation request to allow more data to enter its queue (block 445). The scheduler may then return to block 405 to select another user.

If the user is not a delay sensitive user (block 430), then the scheduler may perform a check to determine if there are more network resources to allocate (block 460). If there are more network resources to allocate, then the scheduler may perform a check to determine if there are more users to schedule (i.e., more resource allocation requests to schedule) (block 465). If there are more users to schedule, then the scheduler may return to block 405 to select another user. If there are no more network resources to allocate or users to schedule, then scheduler operations 400 may terminate.

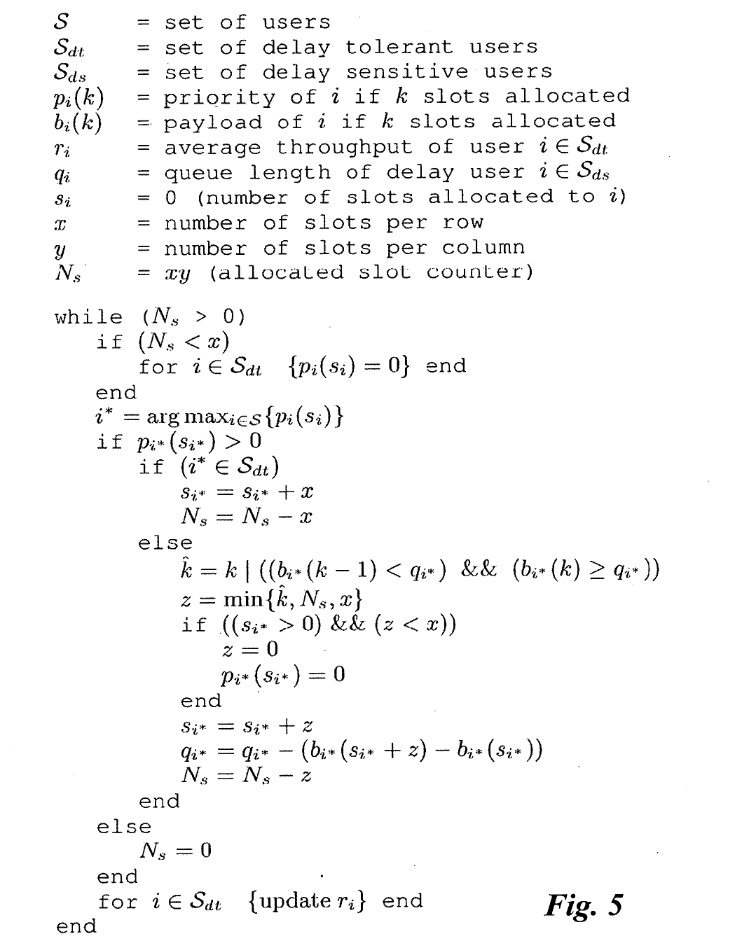

FIG. 5 illustrates a pseudo-code description of scheduler operations 400.

Scheduler operations 500 provide a list of the number of network resources allocated to each user (in the set {sᵢ}). If it is assumed that the delay tolerant connections always have queued data then all network resources of a frame except possibly those in the last row may be allocated to a user. The network resources allocated to users may now be packed into rectangular bursts. In general, network resource allocations to delay tolerant users are multiples of x, the number of network resources per row. Therefore as long as the rows for a user are placed sequentially then the burst is rectangular. The same also holds for those scheduled delay sensitive users for which more than one row's worth of data was queued. Therefore there is only a need to focus on delay tolerant users which were allocated less than x network resources.

FIG. 6 illustrates a flow diagram for base station operations 600 in packing allocated network resources into rectangular bursts. Packing allocated network resources may be a multi-stage process that includes an initial packing that tries to fit the allocated network resources into a frame (block 605) and an iterative filling process that tries to fit any remaining allocated network resources into holes in between rectangular bursts (block 610).

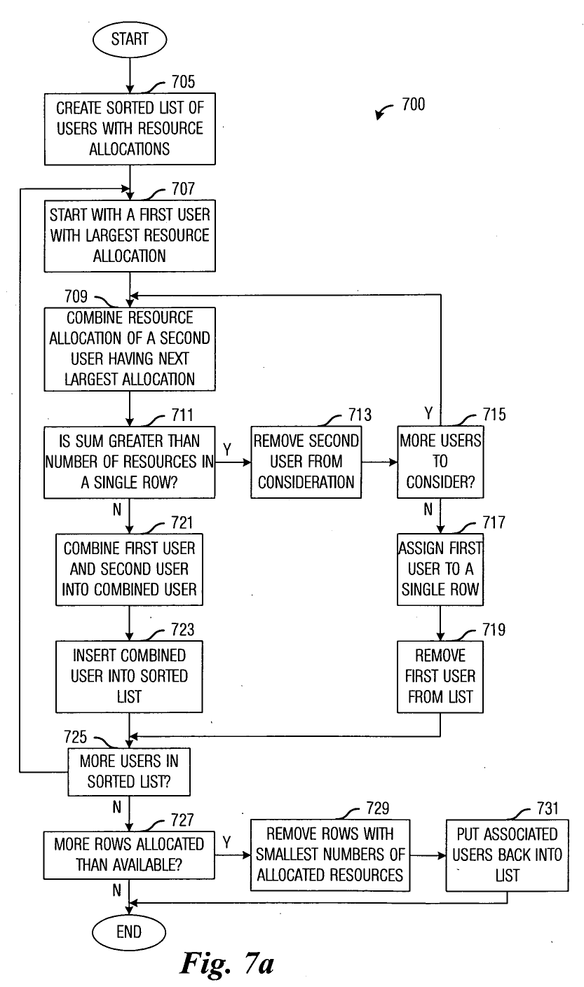

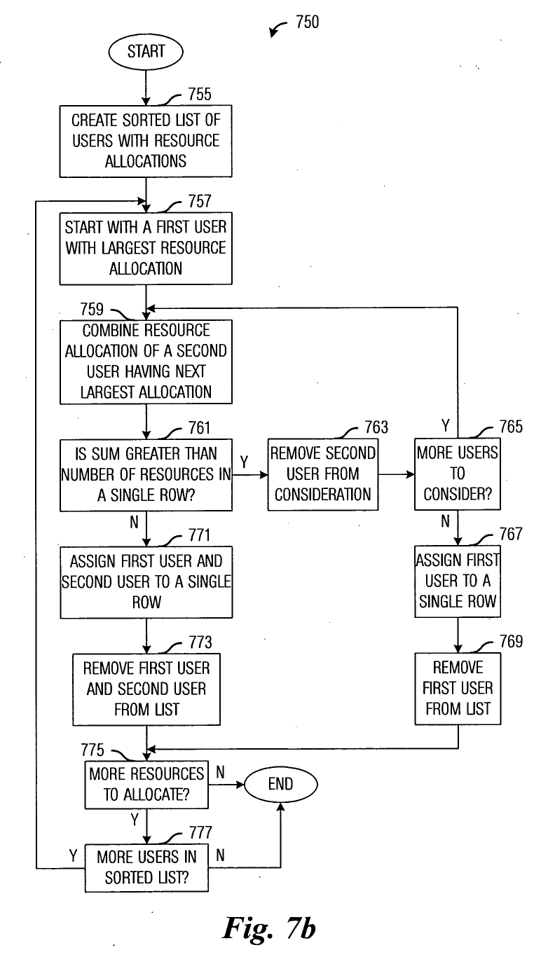

FIG. 7a illustrates a flow diagram for base station operations 700 in an initial packing of allocated network resources into a frame. Base station operations 700 may be an implementation of block 605 of FIG. 6, the initial packing that tries to fit the allocated network resources into a frame. Base station operations 700 may be in continuous operation while the base station is controlling transmissions in a wireless communications system.

The base station may begin with the creation of a sorted list of users and their allocated network resources (block 705). According to a preferred embodiment, the sorted list may be sorted by a number of allocated network resources and may be sorted in ascending order. Although the discussion focuses on the sorted list being sorted in ascending order, the sorted list may also be sorted in descending order with relatively few changes in base station operations 700. Therefore, the discussion should not be construed as being limiting to either the scope or the spirit of the embodiments.

The base station may then continue with the selection of a first user with a largest allocated network resource (block 707). Since the sorted list is sorted in ascending order, a first user with a largest allocated network resource is a user at the end of the sorted list. Then, a second user with a next largest allocated network resource may be selected and their two allocated network resources may be combined (e.g., added) (block 709). The allocated network resource of the second user may be smaller than or equal to the allocated network resource of the first user.

The base station may then perform a check to determine if the combined allocated network resources of the first user and the second user exceeds the number of network resources in a single row (block 711). If the combined allocated network resources exceed the number of network resources in a single row, then the second user may be eliminated from consideration (block 713). The base station may then perform a check to determine if there are more users in the sorted list that have not been considered (block 715). If there are more users in the sorted list that have not been considered, then the base station may return to block 709 to select a new second user with a new next largest allocated network resource, wherein the new second user has not been considered with the first user, and base station operations 700 may continue as described. If there are no more users in the sorted list that have not been considered (block 715), then the base station may assign the first user and its allocated network resource to a single row (block 717) and remove the first user from the sorted list (block 719).

The base station may then perform a check to determine if there are more users in the sorted list (block 725). If there are more users in the sorted list, then the base station may return to block 707 to select a new first user from the sorted list, wherein the new first user has the largest remaining allocated network resource, and base station operations 700 may continue as described. If there are no more users in the sorted list, then base station may perform a check to determine if more rows were allocated than available for use (block 727).

If more rows were allocated than available for use, then the base station may select and remove a number of rows (i.e., a number equal to the amount exceeding the available number of rows) (block 729) and return users associated with the allocated network resources back into the sorted list (block 731). Base station operations 700 may terminate. If fewer rows were allocated than available for use (or if the number of rows that were allocated is equal to the number of rows available for use) then base station operations 700 may terminate.

If the combined allocated network resources of the first user and the second user does not exceed the number of network resources in a single row (block 711), then the base station may combine the first user and the second user to a new first user as well as combine the allocated network resources of the first user and the second user into a single allocated network resource and replace the first user and the second user in the sorted list with the new first user (blocks 721 and 723).

The base station may then perform a check to determine if there are more users in the sorted list (block 725). If there are more users in the sorted list, then the base station may return to block 707 to select a new first user from the sorted list, wherein the new first user has the largest remaining allocated network resource, and base station operations 700 may continue as described. If there are no more users in the sorted list, then base station may perform a check to determine if more rows were allocated than available for use (block 727).

If more rows were allocated than available for use, then the base station may select and remove a number of rows (i.e., a number equal to the amount exceeding the available number of rows) (block 729) and return users associated with the allocated network resources back into the sorted list (block 731). Base station operations 700 may terminate. If fewer rows were allocated than available for use (or if the number of rows that were allocated is equal to the number of rows available for use) then base station operations 700 may terminate.

FIG. 7b illustrates a flow diagram for base station operations 750 in an initial packing of allocated network resources into a frame. Base station operations 750 may be an implementation of block 605 of FIG. 6, the initial packing that tries to fit the allocated network resources into a frame. Base station operations 750 may be in continuous operation while the base station is controlling transmissions in a wireless communications system.

The base station may begin with the creation of a sorted list of users and their allocated network resources (block 755). According to a preferred embodiment, the sorted list may be sorted by a number of allocated network resources and may be sorted in ascending order. Although the discussion focuses on the sorted list being sorted in ascending order, the sorted list may also be sorted in descending order with relatively few changes in base station operations 750. Therefore, the discussion should not be construed as being limiting to either the scope or the spirit of the embodiments.

The base station may then continue with the selection of a first user with a largest allocated network resource (block 757). Since the sorted list is sorted in ascending order, a first user with a largest allocated network resource is a user at the end of the sorted list. Then, a second user with a next largest allocated network resource may be selected and their two allocated network resources may be combined (e.g., added) (block 759). The allocated network resource of the second user may be smaller than or equal to the allocated network resource of the first user.

The base station may then perform a check to determine if the combined allocated network resources of the first user and the second user exceeds the number of network resources in a single row (block 761). If the combined allocated network resources exceed the number of network resources in a single row, then the second user may be eliminated from consideration (block 763). The base station may then perform a check to determine if there are more users in the sorted list that have not been considered (block 765). If there are more users in the sorted list that have not been considered, then the base station may return to block 759 to select a new second user with a new next largest allocated network resource, wherein the new second user has not been considered with the first user, and base station operations 750 may continue as described. If there are no more users in the sorted list that have not been considered (block 765), then the base station may assign the first user and its allocated network resource to a single row (block 767) and remove the first user from the sorted list (block 769).

The base station may then perform a check to determine if there are more network resources to allocate (block 775). If there are more network resources to allocate, then the base station may then perform a check to determine if there are more users in the sorted list (block 777). If there are more users in the sorted list, then the base station may return to block 757 to select a new first user from the sorted list, wherein the new first user has the largest remaining allocated network resource, and base station operations 750 may continue as described. If there are no more network resources to allocate or no more users in the sorted list, then base station operations 750 may terminate.

If the combined allocated network resources of the first user and the second user does not exceed the number of network resources in a single row (block 761), then the base station may assign the first user and the second user to a single row (block 771) and remove the first user and the second user from the sorted list (block 773).

The base station may then perform a check to determine if there are more network resources to allocate (block 775). If there are more network resources to allocate, then the base station may then perform a check to determine if there are more users in the sorted list (block 777). If there are more users in the sorted list, then the base station may return to block 757 to select a new first user from the sorted list, wherein the new first user has the largest remaining allocated network resource, and base station operations 750 may continue as described. If there are no more network resources to allocate or no more users in the sorted list, then base station operations 750 may terminate.

As an example, let a sorted list include: {(A, 1), (B, 3), (C, 3), (D, 5), (E, 8)} and there are two rows, with each row having ten (10) network resources remaining in a frame to be allocated. Base station operations 750 may proceed as follows:

| First User | Second User | Combined Allocation/result |
|---|---|---|
| E | D | 13/exceeds single row |
| E | C | 11/exceeds single row |
| E | B | 11/exceeds single row |
| E | A | 9/allocate users E and A to one row |
| D | C | 8/allocate users D and C to one row |
| B | NONE | 3/no more rows to allocate. |

The resulting network resource allocations from base station operations 750 are as follows:

Row #1—users A and E with one network resource unallocated

Row #2—users C and D with two network resources unallocated.

The sorted list includes: {(B, 3)}.

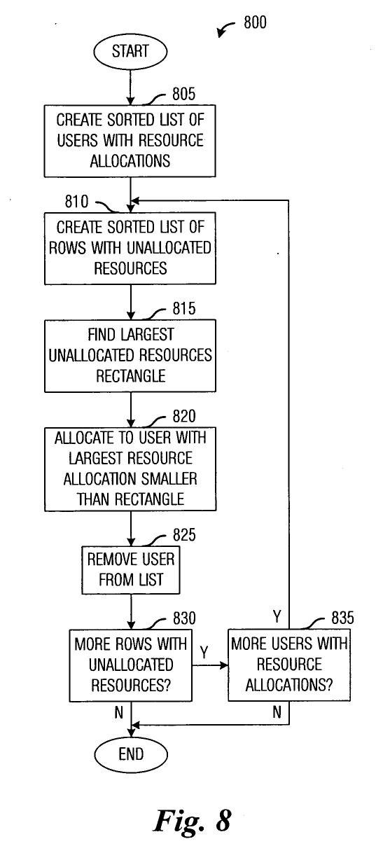

FIG. 8 illustrates a flow diagram for base station operations 800 in an initial packing of allocated network resources into a frame. Base station operations 800 may be an implementation of block 610 of FIG. 6, the iterative filling process that tries to fit any remaining allocated network resources into holes in between rectangular bursts. Base station operations 800 may be in continuous operation while the base station is controlling transmissions in a wireless communications system.

The base station may begin with the creation of a sorted list of users and their allocated network resources (block 805). The sorted list of users comprises users that were not allocated during the operations discussed above (either base station operations 700 or base station operations 750). According to a preferred embodiment, the sorted list of users may be sorted by a number of allocated network resources and may be sorted in ascending order. The base station may also create a sorted list of rows with unallocated network resources (block 810). According to a preferred embodiment, the sorted list of rows may be sorted by a number of unallocated network resources and may be sorted in ascending order, although it is possible to sort in descending order.

The base station may then continue by finding a largest rectangle of unallocated network resources (block 815) and allocate the rectangle of unallocated network resources to a user with a largest allocated network resource that will fit inside the rectangle (block 820). If there are more than one user with the same size allocated network resource, then the base station may select a user based on factors such as user priority, traffic priority, age of allocated network resource request, queue length, and so forth.

The base station may then remove the user from the sorted list of users (block 825). The base station may then perform a check to determine if there are more rows with unallocated network resources (block 830). If there are more rows with unallocated network resources, then the base station may perform a check to determine if there are more users in the sorted list (block 835). If there are more users in the sorted list, then the base station may return to block 810 to re-create the sorted list of rows with unallocated network resources and base station operations 800 may continue as described. If there are no more rows with unallocated network resources or no more users in the sorted list, then base station operations 800 may terminate.

As an example, let there be five rows with unallocated network resources. The sorted list of rows is as follows: {7, 7, 8, 8, 9} wherein the number indicates the number of allocated network resources in a row, with each row having ten (10) network resources. It may then be possible to create a rectangular burst of six network resources from the two rows with seven allocated resources (a rectangle of size 3×2), or a rectangular burst of eight network resources from the two rows with seven allocated network resources and the two rows with eight allocated network resources (a rectangle of size 2×4), or a rectangular burst of five network resources from the two rows with seven allocated network resources, the two rows with eight allocated network resources, and the one row with nine allocated network resources (a rectangle of size 1×5).

Users with allocated network resources may be assigned to these rectangular bursts. A preferred embodiment may be to select the largest rectangular burst that would contain a user with a largest allocated network resource. For example, if the largest allocated network resource for a user is six, then the rectangular burst of six network resources from the two rows with seven allocated resources may be chosen. Alternatively, the largest allocated network resource may be assigned to a largest rectangular burst. Other assignment techniques may also be utilized. After a user has been assigned to a rectangular burst, a reordering of the sorted list of rows may need to take into account of the possibility of holes in the network resources in the rows. The process may continue until all network resources are allocated or all users are assigned.

As an example, let N be an ordered list of rows having unallocated network resources and S be an ordered list of users that remain unallocated, then an algorithm to assign users to rectangular bursts may be described using pseudo-code as:

```
  Repeat while S is not empty {
  Select a user with largest allocated network resources from S (let U be
the selected user and F(U) be the size of the user’s allocated network
resources;
    For i = 1:N
    Find largest rectangular burst in the first i rows
      If size of largest rectangular burst > F(U), place U in rectangular
      burst
      Resort N
    End (For)
  Remove U from S
End (Repeat).
```

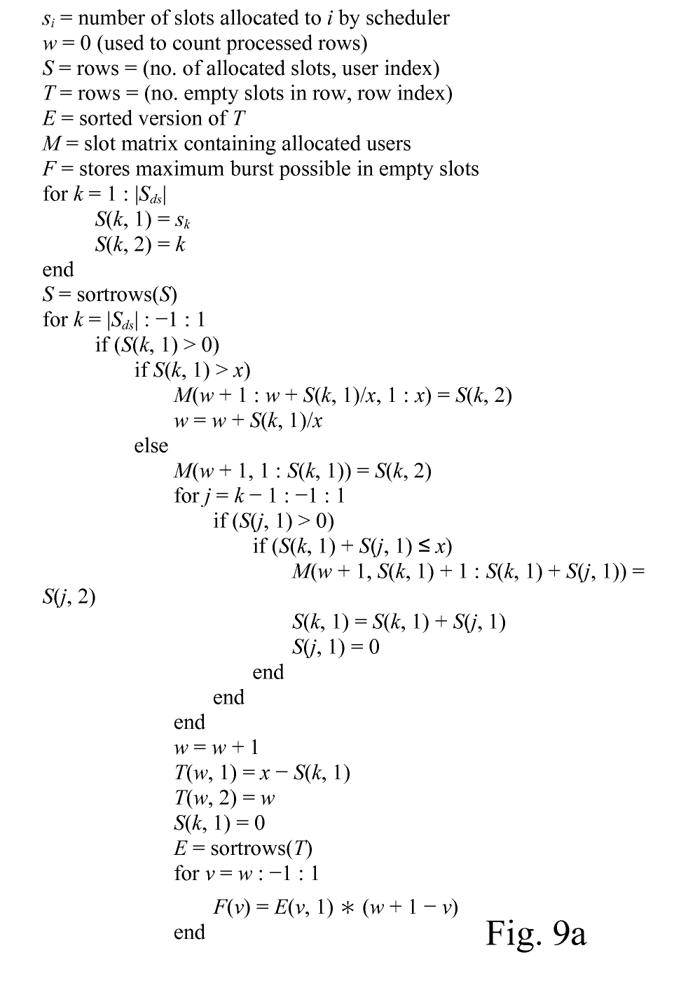

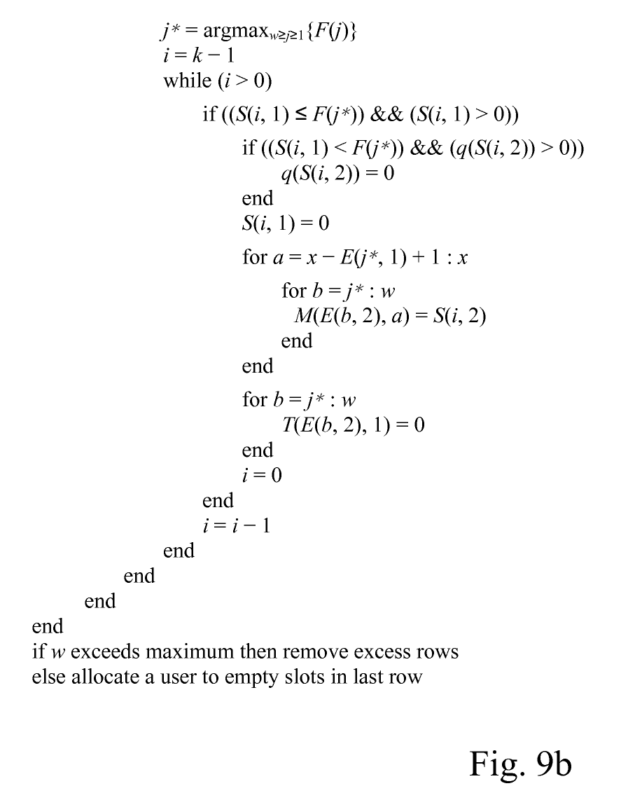

FIG. 9 illustrates a pseudo-code description of base station operations 600.

Several performance metrics are evaluated and compared using simulation studies. The performance metrics include: Packing Efficiency (ratio of allocated slots to total slots); Signaling efficiency (average number of users scheduled per frame). This number can also be used to compare coding gains since as the average number of scheduled users decreases, the average amount of data served per burst increases and hence the coding gain increases; Sum Utility (represents the scheduler performance); and QoS metrics (throughput, average delay, packet loss rate, etc.). Although this information is captured by the sum utility, it is useful to see how each is affected.

The determination of the optimal solution is computationally intensive so an alternate comparison is performed instead: If the restriction of the need for rectangular bursts is removed, then the solution that maximizes the sum utility by allocating one slot per iteration may be computed. Therefore this provides an upper bound on the optimal solution. This solution has a packing efficiency of 100% but has a high signaling overhead (since many users are simultaneously scheduled). The solution provided by the techniques discussed previously is compared to the upper bound. Also, the signaling overheads are compared.

A simplified model for the radio channel is used since the interest lies in rectangular burst packing. Assumptions include five possible channel rates (Modulation and Coding schemes). At the lowest rate a payload of b bits can be transmitted in a network resource. The other rates can carry payloads of 2b, 3b, 4b, and 5b bits. Monte Carlo simulations were performed and for each simulation run, the payload per slot for each user was randomly determined and the simulation continued until steady state is achieved. Several runs are made and each metric is averaged over these runs. Each frame is assumed to contain 8 slots per row and 30 slots per column for a total of 240 slots. This corresponds to a typical WiMAX frame of duration 5 ms and a bandwidth of 10 MHz.

For the baseline problem, 10 delay tolerant users were assumed and that each user always has a full buffer of data. For these users a proportional fair utility function U(r)=ln(r) was used to obtain proportionally fair throughputs. Also 20 delay sensitive users were assumed. Each delay sensitive user receives a packet every frame period. The packet size is equally likely to be 9b or 15b. Therefore, since an average of 3b bits are served per network resource (average over channel rates) and an average of 12b bits arrive per frame then this means an average of 4 network resources (half of a row) is required for each user so that an average of 10 rows are used by the delay sensitive users. A queue-based utility function for the delay sensitive users given by U(q)=1000rate/(qₘₐₓ−q) is used, where qₘₐₓ is the maximum allowed queue size. The simulations used qₘₐₓ=36b. The factor of 1000 was used to ensure that the delay sensitive users were given higher priority over the delay tolerant ones. One can fine tune this parameter to obtain the best trade-off between QoS guarantees and user diversity gains.

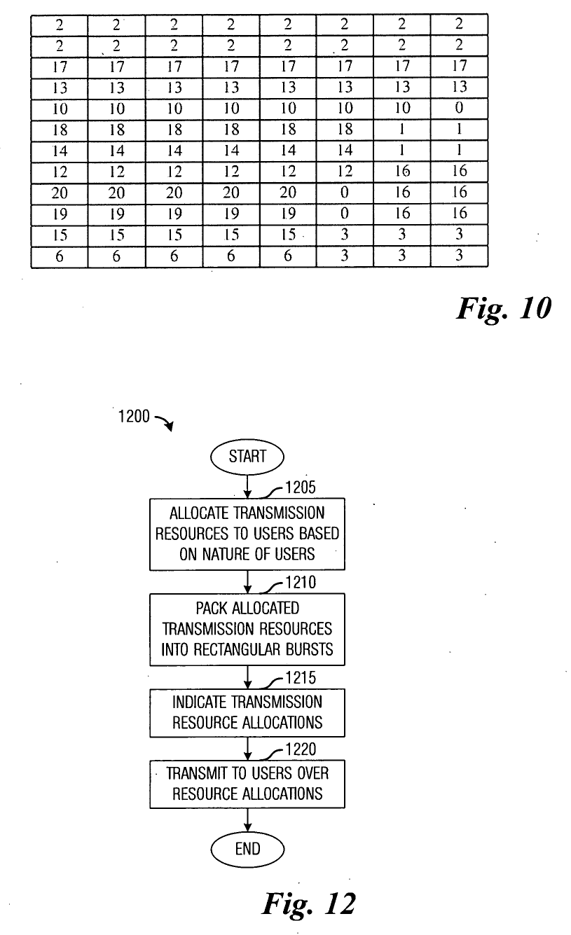

First, a typical allocation scheme produced by the above discussed techniques is discussed. For this example the baseline parameters were used, but with an average offered load of 24b bits per frame for each delay sensitive user. For this particular frame the slot allocations for the delay tolerant users is given by \tilde{s}=[4 16 5 24 24 5 16 16 24 7 24 6 8 6 5 5 8 6 5 5]. FIG. 10 illustrates the last 12 rows of the slot (network resource) assignments. A zero (0) indicates an empty slot. Note the rectangular burst assignments for users 1, 3 and 16. However users 3 and 16 are each allocated 5 slots by the scheduler but 6 slots in the frame. Any additional data in its queue is placed in the extra slot but in general this may mean some throughput loss. The throughput loss will be observed when other metrics are examined, such as utility.

Next, the packing efficiency of the above discussed techniques is examined. Note that the packing algorithm may end up needing more rows than available in the frame. Any excess rows are removed when computing efficiency. Also note that the last row will contain the largest number of empty slots but these will be sequential. Therefore an additional burst of data is inserted into these slots at the expense of additional signaling. In Table I the average packing efficiency for the frames output by the above discussed techniques is provided.

TABLE I
Packing Efficiency, Signaling Overhead, and Performance.

Average User Load

| | 6b | 12b | 18b | 24b |
|---|---|---|---|---|
| Packing | 0.999 | 0.997 | 0.992 | 0.993 |
| Efficiency | | | | |
| Signaling | 0.988 | 1.026 | 0.966 | 0.723 |
| Overhead | | | | |
| Ratio of Utilities | 0.990 | 0.984 | 0.988 | 0.980 |

Results for various user loads (normalized by b) are provided. Note that the efficiency remains at least 99% for a wide range of loads. At zero offered load the efficiency is 100% since all allocations are for delay tolerant users. As the load increases the efficiency decreases because of the packing. However, for very high loading it once again increases. This is due to the fact that more slots are allocated to delay tolerant traffic and this increases the multiplexing gains.

Next the signaling overhead savings that can potentially be obtained by the above discussed techniques is investigated. In Table I, the average number of users allocated to a frame for the above discussed techniques divided with that for the optimal algorithm is shown. At high loads fewer delay tolerant users are scheduled and this results in reduced signaling overhead.

The packing efficiency and signaling overhead do not completely provide the performance characteristics of the above discussed techniques. For example it may be possible to serve a single user at a time and maximize the packing efficiency while minimizing the signaling overhead. The objective that is being optimized is the sum utility and hence this captures the overall performance of the algorithm. Other metrics that are of interest include the average and maximum queue of the delay sensitive users as well as the total throughput and the fairness of the delay tolerant users. The Jain Fairness index (please refer to R. Jain, D. Chiu, and W. Hawe, “A Quantitative Measure Of Fairness And Discrimination For Resource Allocation In Shared Computer Systems”, DEC Research Report TR-301, September 1984, which is incorporated herein by reference for a discussion of the Jain Fairness index) to represent the fairness of the throughput of the delay tolerant users.

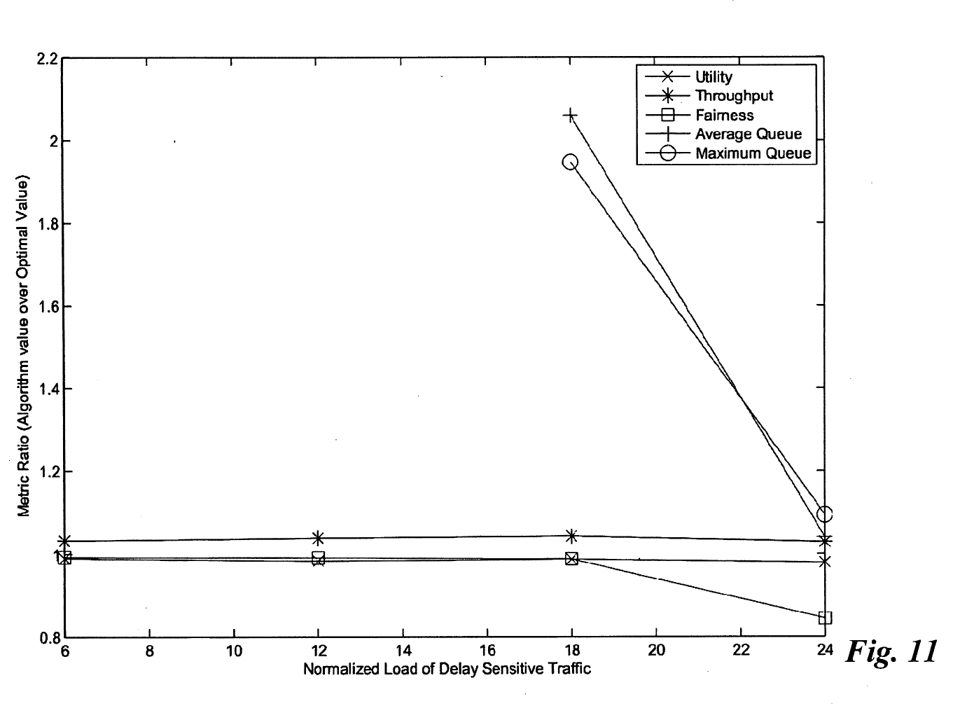

Again the baseline problem is used and the offered load of each of the delay sensitive users is varied. For each metric of concern the ratio of the metric for the above discussed techniques to the value for the optimal solution (obtained without the rectangular burst constraint). FIG. 11 illustrates a data plot of the ratios for the utility, the throughput, the fairness and the average and maximum queue size. In general, the performance of the above discussed techniques decreases relative to the optimal solution as the loading increases. However the performance degradation is small. Recall that the packing efficiency remains high even with high loads so the decrease in performance is due to the fact that the allocation granularity is coarse. However since less resources are required for signaling then some of this loss can be recuperated by using these extra resources for data.

In the previous simulation slots along the time dimension first were allocated first. Instead allocate resources along the frequency dimension may be allocated first. However, for this particular case this would mean allocating 30 slots to a best effort user if one is chosen. Instead the frame is broken into two halves along the horizontal direction. Then resources for the top half and then the bottom half are allocated with allocations along the frequency dimension first. The above discussed techniques may be used to solve this problem. For example, if there are eight (8) slots in the time direction and 30 in the frequency direction, then x=30/2 and y=2×8 and the problem may be solved as before. There are many ways to fragment the frame.

The baseline problem was simulated and again the offered load was varied, values of x=15 and y=16 were used. The resulting metrics (all normalized by the corresponding value of the optimal solution) are provided in Table II. The performance is similar to that of the baseline problem.

TABLE II
Packing Efficiency, Signaling Overhead, and Performance.

Average User Load

| | 6b | 12b | 18b | 24b |
|---|---|---|---|---|
| Packing | 0.999 | 0.998 | 0.994 | 0.989 |
| Efficiency | | | | |
| Signaling | 0.989 | 1.022 | 0.922 | 0.640 |
| Overhead | | | | |
| Ratio of Utilities | 0.990 | 0.980 | 0.990 | 0.955 |

FIG. 12 illustrates a flow diagram of base station operations 1200 in transmitting information to users. Base station operations 1200 may be indicative of operations taking place in a base station of a wireless communications system as the base station allocates network resources to users and then transmits information to the users using the allocated network resources.

The base station may begin by allocating network resources to users based on the nature of the user (block 1205). The base station may allocate network resources based on delay characteristics of the users as well as the amount of information in data queues associated with each user. After allocating the network resources to the users, the base station may pack allocated network resources that are not an entire row in size into rectangular bursts (block 1210).

With the allocated network resources assigned and packed, the base station may indicate locations of the allocated network resources to the users (block 1215). As discussed previously, the indications of the locations of the allocated network resources may be carried in a DL-MAP portion of a frame. The indications inform the individual users when to listen to detect transmissions intended for them. The base station may then transmit information to the users over the allocated network resources. Base station operations 1200 may then terminate.

The order of the events described herein may be changed, the operations may be performed in a different order, or some of the operations may be performed at the same time to meet particular requirements of the various embodiments.

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for allocating resources in a wireless communications system, the method comprising:
allocating resource units to users in the wireless communications system, the allocating is based on delay characteristics of the user and an amount of information to be transmitted to each user; and
packing allocated resource units into rectangular bursts for transmission.

2. The method of claim 1, wherein the allocating resource units comprises:
selecting a user from a plurality of users;
computing a number of resource units to allocate to the selected user, the computing is based on the delay characteristics of the user and a queue length of a data queue associated with the selected user; and
allocating the number of resource units to the selected user.

3. The method of claim 2, wherein the computing a number of resource units comprises:
in response to determining that the user is delay tolerant,
setting the number of resource units to N resource units in response to determining that the user's data queue has a queue length of greater than or equal to N, wherein N is the number of resource units in a row of resource units; and
setting the number of resource units to zero (0) resource units in response to determining that the user's data queue has a queue length of less than N.

4. The method of claim 3, wherein the computing a number of resource units further comprises:
in response to determining that the user is delay sensitive,
setting the number of resource units to N resource units in response to determining that the user's data queue has a queue length of greater than or equal to N and that the user has been allocated resource units in less than Y time units;
setting the number of resource units equal to the queue length of the user's data queue in response to determining that the user's data queue has a queue length of less than N and that the user has not been allocated resource units in less than Y time unit; and
setting the number of resource units to zero (0) resource units in response to determining that the user's data queue has a queue length of less than N and that the user has been allocated resource units in less than Y time units.

5. The method of claim 2, further comprising, repeating the selecting, the computing, and the allocating the number of resource units until there are no more users in the plurality of users and there are no more resource units to allocate.

6. The method of claim 2, wherein the selecting a user comprises selecting a user from the plurality of users, wherein the selected user has a largest utility gain per additional resource unit.

7. The method of claim 1, wherein the packing allocated resource units comprises:
initially packing allocated resource units into rows of unallocated resource units; and
filling holes of unallocated resource units in the rows of unallocated resource units.

8. The method of claim 7, wherein the initially packing comprises:
a) creating a sorted list, the sorted list comprising users and their allocated resource units;
b) selecting a first user, the first user having an allocated resource units of largest number;
c) combining the allocated resource units of the first user with allocated resource units of a second user, the second user having an allocated resource units of second largest number;
d) in response to determining that the combined allocated resource units is greater than N, wherein N is the number of resource units in a row of resource units,
removing the second user from consideration,
in response to determining that there are additional users in the sorted list,
selecting a new second user,
repeating the combining and the steps d) and e),
in response to determining that there are no additional users in the sorted list,
assigning the first user's allocated resource units to a single row,
removing the first user from the sorted list;
e) in response to determining that the combined allocated resource units is less than or equal to N,
assigning the first user's allocated resource units and the second user's allocated resource units to a single row,
removing the first user and the second user from the sorted list; and
f) repeating the steps b), c), d), and e) in response to determining that there are additional unallocated resource units to allocate and there are additional users in the sorted list.

9. The method of claim 8, wherein the sorted list is sorted in ascending order of allocated resource units.

10. The method of claim 7, wherein the filling holes comprises:
i) creating a sorted list of users, the sorted list of users comprises users and their allocated resource units;
ii) creating a sorted list of rows with unallocated resource units;
iii) finding a largest unallocated resources rectangle; and
iv) allocating a user to the largest unallocated resources rectangle.

11. The method of claim 10, wherein the filling holes further comprises:
removing the user from the sorted list of users; and
repeating the steps ii), iii), and iv) in response to determining that there are additional rows with unallocated resource units and that there are additional users in the sorted list of users.

12. The method of claim 10, wherein the allocating a user to the largest unallocated resources rectangle comprises allocating a user with an allocated resource units of largest number that is smaller than the largest unallocated resource rectangle to the largest unallocated resources rectangle.

13. The method of claim 7, wherein the initially packing comprises:
A) creating a sorted list, the sorted list comprising users and their allocated resource units;
B) selecting a first user, the first user having an allocated resource units of largest number;
C) combining the allocated resource units of the first user with allocated resource units of a second user, the second user having an allocated resource units of second largest number;
D) in response to determining that the combined allocated resource units is greater than N, wherein N is the number of resource units in a row of resource units,
removing the second user from consideration,
in response to determining that there are additional users in the sorted list,
selecting a new second user,
repeating the combining and the steps d) and e),
in response to determining that there are no additional users in the sorted list,
assigning the first user's allocated resource units to a single row,
removing the first user from the sorted list;
E) in response to determining that the combined allocated resource units is less than or equal to N,
combining the first user and the second user into a new first user,
combining the allocated resource units of the first user and the allocated resource units of the second user into allocated resources units of the new first user,
inserting the new first user and its allocated resource units into the sorted list;
F) repeating the steps B), C), D), and E) in response to determining that there are additional users in the sorted list; and
G) trimming rows in response to determining that more rows were allocated than rows available.

14. The method of claim 13, wherein the trimming comprises:
selecting Z rows having the fewest number of allocated network resources, wherein Z is a difference between the number of rows allocated and the number of available rows;
deleting the Z rows; and
inserting users associated with network resources allocated in the Z rows into the sorted list.

15. A method for allocating resources in a wireless communications system, the method comprising:
allocating resource units to users in the wireless communications system, the allocating is based on delay characteristics of the user and an amount of information to be transmitted to each user;
assigning allocated resource units of size M*N to M rows of resource units, wherein M is an integer and N is the number of resource units in a row of resource units; and
packing allocated resource units of size less than N into rectangular bursts.

16. The method of claim 15, wherein the allocating resource units comprises:
selecting a user from a plurality of users, the selecting is based on a metric;
computing a number of resource units to allocate to the selected user, the computing is based on the delay characteristics of the user and a queue length of a data queue associated with the selected user; and
allocating the number of resource units to the selected user.

17. The method of claim 15, wherein the packing allocated units of size less than N comprises:
initially packing allocated resource units of size less than N into rows of unallocated resource units; and
filling holes of unallocated resource units in the rows of unallocated resource units.

18. A method for transmitting information in a wireless communications system, the method comprising:
allocating resource units to users in the wireless communications system, the allocating is based on delay characteristics of the user and an amount of information to be transmitted to each user;
packing allocated resource units into rectangular bursts for transmission;
indicating allocated resource units to users; and
transmitting to users using the allocated resource units.

19. The method of claim 18, wherein the packing comprises:
assigning allocated resource units of size M*N to M rows of resource units, wherein M is an integer and N is the number of resource units in a row of resource units; and
packing allocated resource units of size less than N into rectangular bursts for transmission.

20. The method of claim 18, wherein the indicating comprises, for each users' allocated resource units, placing a pointer value indicating a starting position of the allocated resource units, a width value indicating a width of the allocated resource units, and a height value indicating a height of the allocated resource units into a resource map.

21. The method of claim 20, wherein the resource map is transmitted to the users prior to the transmitting.
